(19) United States
(12) Patent Application Publication
(10) Pub. No.: US 2018/0314894 A1
(43) Pub. Date: Nov. 1, 2018

(54) METHOD, AN APPARATUS AND A COMPUTER PROGRAM PRODUCT FOR OBJECT DETECTION

(71) Applicant: Nokia Technologies Oy, Espoo (FI)

(72) Inventor: Tinghuai WANG, Tampere (FI)

(21) Appl. No.: 15/956,878

(22) Filed: Apr. 19, 2018

(30) Foreign Application Priority Data
Apr. 28, 2017 (GB) 1706763.8

(51) Int. Cl. G06K 9/00; G06T 7/20

(52) U.S. Cl. CPC G06K 9/00718; G06K 9/00771; G06T 2207/10016; G06T 2207/20084; G06T 7/20

(57) ABSTRACT

A method, an apparatus and a computer program product are provided, wherein the method comprises receiving a video comprising video frames as an input; generating set of object proposals from the video, the set of object proposals comprising positive object proposals and negative object proposals; generating object tracklets comprising regions appearing in consecutive frames of the video, said regions corresponding to object proposals with a high confidence; constructing a graph for the object proposals to rescore the object proposals in the generated object tracklets; and aggregating the rescored object proposals to produce an object detection.

### CROSS-REFERENCE TO RELATED APPLICATIONS

This application claims priority to GB Application No. 1706763.8, filed Apr. 28, 2017, the entire contents of which are incorporated herein by reference.

### TECHNICAL FIELD

The present solution generally relates to computer vision and artificial intelligence. In particular, the present solution relates to a method and technical equipment for object detection.

### BACKGROUND

Many practical applications rely on the availability of semantic information about the content of the media, such as images, videos, etc. Semantic information is represented by metadata which may express the type of scene, the occurrence of a specific action/activity, the presence of a specific object, etc. Such semantic information can be obtained by analyzing the media.

The analysis of media is a fundamental problem which has not yet been completely solved. This is especially true when considering the extraction of high-level semantics, such as object detection and recognition, scene classification (e.g., sport type classification) action/activity recognition, etc.

### SUMMARY

Now there has been invented an improved method and technical equipment implementing the method, by which objects can be detected from video content. Various aspects of the invention include a method, an apparatus, and a computer readable medium comprising a computer program stored therein, which are characterized by what is stated in the independent claims. Various embodiments of the invention are disclosed in the dependent claims.

According to a first aspect, there is provided a method comprising receiving a video comprising video frames as an input; generating set of object proposals from the video, the set of object proposals comprising positive object proposals and negative object proposals; generating object tracklets comprising regions appearing in consecutive frames of the video, said regions corresponding to object proposals with a high confidence; constructing a graph for the object proposals to rescore the object proposals in the generated object tracklets; and aggregating the rescored object proposals to produce an object detection.

According to a second aspect, there is provided an apparatus comprising at least one processor, memory including computer program code, the memory and the computer program code configured to, with the at least one processor, cause the apparatus to receive a video comprising video frames as an input; generate set of object proposals from the video, the set of object proposals comprising positive object proposals and negative object proposals; generate object tracklets comprising regions appearing in consecutive frames of the video, said regions corresponding to object proposals with a high confidence; construct a graph for the object proposals to rescore the object proposals in the generated object tracklets; and aggregating the rescored object proposals to produce an object detection.

According to a third aspect, there is provided computer program product embodied on a non-transitory computer readable medium, comprising computer program code configured to, when executed on at least one processor, cause an apparatus or a system to receive a video frame as an input; receive a video comprising video frames as an input; generate set of object proposals from the video, the set of object proposals comprising positive object proposals and negative object proposals; generate object tracklets comprising regions appearing in consecutive frames of the video, said regions corresponding to object proposals with a high confidence; construct a graph for the object proposals to rescore the object proposals in the generated object tracklets; and aggregate the rescored object proposals to produce an object detection.

According to an embodiment negative object proposals are defined to be such object proposals whose detection score is below a first threshold.

According to an embodiment object proposals with high confidence are defined as object proposals having detection score exceeding a second threshold.

According to an embodiment, generating object tracklets comprises tracking a proposal with a high confidence bidirectionally in the video sequence.

According to an embodiment, generating object tracklets further comprises performing tracking iteratively.

According to an embodiment, rescoring the object proposals comprises two separable confidence propagation processes from labeled nodes to unlabeled nodes respectively.

According to an embodiment, two separable confidence propagation processes are performed simultaneously.

According to an embodiment a graph optimization is determined by minimizing an energy function with respect to all nodes' confidence.

### DESCRIPTION OF THE DRAWINGS

In the following, various embodiments of the invention will be described in more detail with reference to the appended drawings, in which

FIG. 1 shows a computer system suitable to be used in a computer vision process according to an embodiment;

FIG. 2 shows an example of a Convolutional Neural Network that may be used in computer vision systems;

FIG. 3 shows a simplified example of a method according to an embodiment;

FIG. 4 shows an example of a tracklet graph; and

FIG. 5 is a flowchart of a method according to an embodiment.

### DESCRIPTION OF EXAMPLE EMBODIMENTS

In the following, several embodiments of the invention will be described in the context of computer vision. In particular, the present embodiments are related to video object detection, a purpose of which is to detect instances of semantic objects of a certain class in videos. Video object detection has applications in many areas of computer vision, for example, in tracking, classification, segmentation, captioning and surveillance.

Despite the significant performance improvement of image object detection, video object detection brings up new challenges on how to solve the object detection problem for videos robustly and effectively. Simply applying image based object detection on video frames typically suffers from large appearance changes and occlusions of objects in natural videos. There have been approaches on detecting one specific class of objects in videos, such as cars and pedestrians. The present embodiments are targeted to a problem of detecting more general semantic objects in videos.

The present embodiments comprises detecting objects in video comprising video frames by utilizing off-the-shelf image based detection for objects appearing in consecutive frames. The embodiments form a graph of all candidate tracklets and rescore each constituent object proposal combining both local and global context cues. Graphs are formed and optimized in relation to objects, so no extra training or training data or annotated video data to train SVM (Support Vector Machine) and CNN (Convolutional Neural Network) classifiers is required. The graph may be optimized by minimizing energy function with regard to all nodes confidence and perform Non-maximum Suppression (NMS) to select box with highest confidence as the detected object in case of overlapping or non-overlapping object proposals.

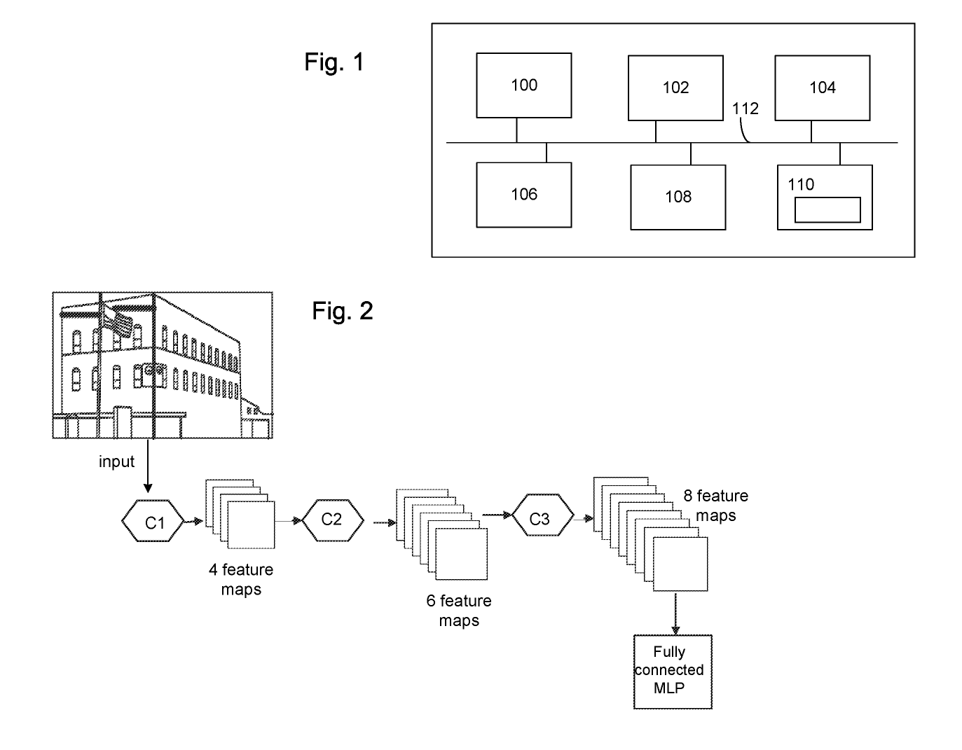

FIG. 1 shows a computer system suitable to be used in image processing, for example in computer vision process according to an embodiment. The generalized structure of the computer system will be explained in accordance with the functional blocks of the system. Several functionalities can be carried out with a single physical device, e.g. all calculation procedures can be performed in a single processor if desired. A data processing system of an apparatus according to an example of FIG. 1 comprises a main processing unit 100, a memory 102, a storage device 104, an input device 106, an output device 108, and a graphics subsystem 110, which are all connected to each other via a data bus 112.

The main processing unit 100 is a processing unit comprising processor circuitry and arranged to process data within the data processing system. The memory 102, the storage device 104, the input device 106, and the output device 108 may include conventional components as recognized by those skilled in the art. The memory 102 and storage device 104 store data within the data processing system 100. Computer program code resides in the memory 102 for implementing, for example, computer vision process. The input device 106 inputs data into the system while the output device 108 receives data from the data processing system and forwards the data, for example to a display, a data transmitter, or other output device. The data bus 112 is a conventional data bus and while shown as a single line it may be any combination of the following: a processor bus, a PCI bus, a graphical bus, an ISA bus. Accordingly, a skilled person readily recognizes that the apparatus may be any data processing device, such as a computer device, a personal computer, a server computer, a mobile phone, a smart phone or an Internet access device, for example Internet tablet computer.

It needs to be understood that different embodiments allow different parts to be carried out in different elements. For example, various processes of the computer vision system may be carried out in one or more processing devices; for example, entirely in one computer device, or in one server device or across multiple user devices. The elements of computer vision process may be implemented as a software component residing on one device or distributed across several devices, as mentioned above, for example so that the devices form a so-called cloud.

One approach for the analysis of data in general and of visual data in particular is deep learning. Deep learning is a sub-field of machine learning. Deep learning may involve learning of multiple layers of nonlinear processing units, either in supervised or in unsupervised manner. These layers form a hierarchy of layers, which may be referred to as artificial neural network. Each learned layer extracts feature representations from the input data, where features from lower layers represent low-level semantics (i.e. more abstract concepts). Unsupervised learning applications may include pattern analysis (e.g. clustering, feature extraction) whereas supervised learning applications may include classification of image objects.

Deep learning techniques allow for recognizing and detecting objects in images or videos with great accuracy, outperforming previous methods. One difference of deep learning image recognition technique compared to previous methods is learning to recognize image objects directly from the raw data, whereas previous techniques are based on recognizing the image objects from hand-engineered features (e.g. SIFT features). During the training stage, deep learning techniques build hierarchical layers which extract features of increasingly abstract level.

Thus, an extractor or a feature extractor may be used in deep learning techniques. An example of a feature extractor in deep learning techniques is the Convolutional Neural Network (CNN), shown in FIG. 2. A CNN may be composed of one or more convolutional layers with fully connected layers on top. CNNs are easier to train than other deep neural networks and have fewer parameters to be estimated. Therefore, CNNs have turned out to be a highly attractive architecture to use, especially in image and speech applications.

In FIG. 2, the input to a CNN is an image, but any other media content object, such as video or audio file, could be used as well. Each layer of a CNN represents a certain abstraction (or semantic) level, and the CNN extracts multiple feature maps. The CNN in FIG. 2 has only three feature (or abstraction, or semantic) layers C1, C2, C3 for the sake of simplicity, but top-performing CNNs may have over 20 feature layers.

The first convolution layer C1 of the CNN consists of extracting 4 feature-maps from the first layer (i.e. from the input image). These maps may represent low-level features found in the input image, such as edges and corners. The second convolution layer C2 of the CNN, consisting of extracting 6 feature-maps from the previous layer, increases the semantic level of extracted features. Similarly, the third convolution layer C3 may represent more abstract concepts found in images, such as combinations of edges and corners, shapes, etc. The last layer of the CNN (fully connected MLP) does not extract feature-maps. Instead, it may use the feature-maps from the last feature layer in order to predict (recognize) the object class. For example, it may predict that the object in the image is a house.

It is appreciated that the goal of the neural network is to transform input data into a more useful output. One of the examples is classification, where input data is classified into one of N possible classes (e.g., classifying if an image contains a cat or a dog). Another example is regression, where input data is transformed into a Real number (e.g. determining the music beat of a song). Yet, another example is generating an image from a noise distribution.

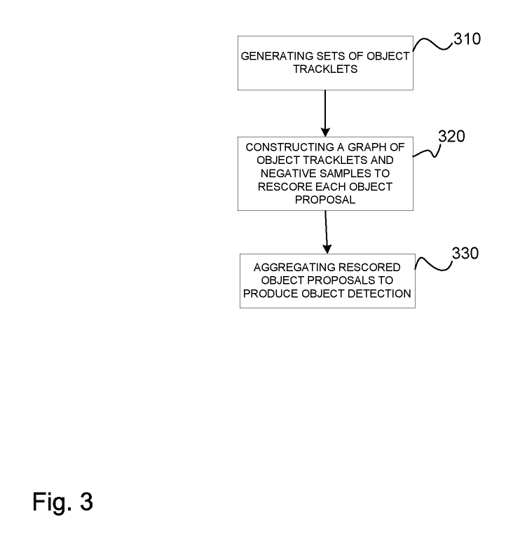

FIG. 3 shows, in a simplified manner, the method for video object detection according to an embodiment. The method comprises the following: generating sets of spatial-temporally associated regions corresponding to the same objects appearing in consecutive frames, i.e. object tracklets 310; constructing a graph of object tracklets and negative samples to rescore each object proposal 320; and aggregating rescored object proposals to produce the object detection 330.

In the following, each of these steps is discussed in more detailed manner.

### Generating Object Tracklets

Object proposals may be generated by computing a hierarchical segmentation of an input video frame that is received by the system. The input video frame may be obtained by a camera device comprising the computer system of FIG. 1. Alternatively, the input video frame can be received through a communication network from a camera device that is external to the computer system of FIG. 1.

One of the known methods for generating object proposals has been disclosed in “Ian Endres and Derek Hoeim; Category independent object proposals, ECCV, pages 575-588, 2010”. The process produces bottom-up grouped object-like regions, i.e. object proposals. As the majority object proposals are negative, and may not correspond to any objects, an off-the-shelf object detector trained on still images is used in the present embodiments.

An example of such object detector is a fast R-CNN (Fast Region-based Convolutional Network). According to present embodiments, the Fast R-CNN takes as input a video frame and a set of object proposals. The network first processes the video frame with several convolutional layers and max pooling layers to produce a feature map. Then for each objet proposal of the set of object proposals a region of interest (RoI) pooling layer extracts a fixed-length feature vector from the feature map. Each feature vector is fed into a sequence of fully connected layers that finally branch into two sibling output layers: one that produces softmax probabilities, and one that produces per-class bounding-box regression offsets. The Fast R-CNN is used to remove negative object proposals whose detection score of PASCAL VOC 20 classes are below a first threshold, for example 0.1.

The remaining object proposals in the set of object proposals are assigned with a label with respect to the highest scoring class from R-CNN, and a set of object proposals Ω is formed. A subset of object proposals is defined with high confidence Ω+⊆Ω whose detection score exceeds a second threshold, e.g. 0.5. The negative proposals in each frames are also randomly sampled, by selecting boxes whose Intersection-over-Union (IoU) with any proposal Ω+ are less than a third threshold, e.g. 0.3, to form a negative proposal set Ω−.

For each object class, tracklets are generated for example by tracking object proposals with high confidence Ω+. The tracking may be performed bidirectionally in the video sequence using visual tracker, e.g. SRDCF (Spatially Regularized Discriminative Correlation Filter) tracker. The SRDCF tracker has been disclosed in “Martin Danelljan, Gustav Hager, Fahad Shahbaz Khan, and Michael Felsberg. Learning spatially regularized correlation filters for visual tracking, ICCV, pages 4310-4318, 2015”. The tracking starts from the proposal with the highest detection confidence in the sequence. During tracking, any object proposals from the set of object proposals Ω, whose boxes have a sufficient (e.g. >0.3) IoU with the tracker box are selected as candidates. The object proposal with the highest detection confidence on each frame is finally chosen to be added to the tracklet. The tracking is performed simultaneously forward and backward to both ends of sequence, and these two tracklets are concatenated to form one complete tracklet. It is to be noticed that a perfect tracking is not assumed against heavy occlusions or large motions, as object tracklets with short-range spatial-temporal coherence within only a few frames are required at this stage. This process may be performed iteratively until all proposals with high confidence from Ω+ are assigned to at least one tracklet. Finally, a set of noisy tracklets denoted as T are extracted. The noisy tracklets contain both high confident proposals and weak detections.

### Rescoring Object Proposals

Given the generated noisy object tracklets preserving short-range spatial-temporal consistence, a graphical model is proposed to rescore the confidence of tracklets with respect to the long-range context and high-level tracklets relationships. A weighted space-time graph is defined on positive and negative object proposals from Gₜ=(νₜ,εₜ) T and Ω respectively. Object proposals from the same tracklet form an undirected acyclic sub-graph; every two sub-graphs formed by tracklets from T are then connected via the k-nearest neighbors among all the constituent nodes; nodes from Ω− are added to the graph by connecting to the k-nearest other negative nodes or tracklets, where the nearest nodes of each tracklet subgraph is connected. This graph is constructed to account for both the local coherence and longer-range tracklet relationships. Negative examples are sparsely connected to calibrate the noisy positive detections, and sparsity is preserved to facilitate efficient and effective information flowing within structural properties during inference.

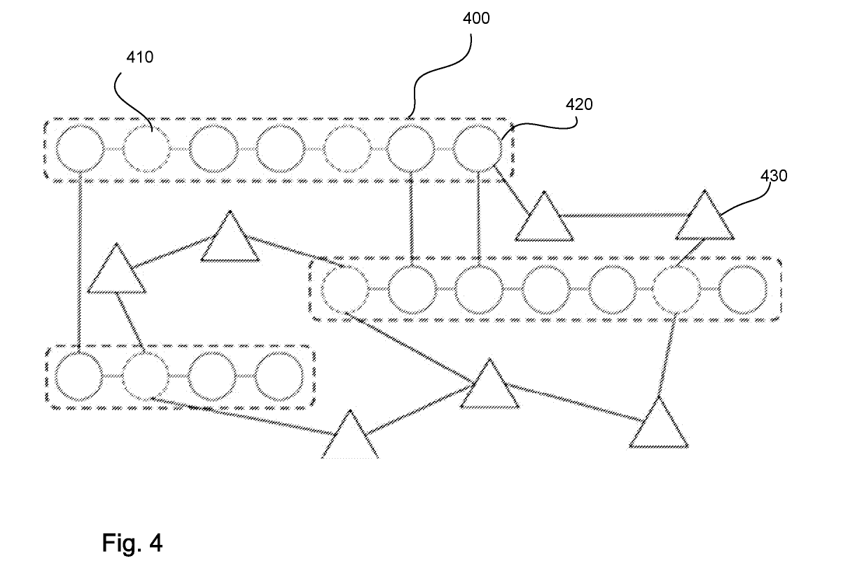

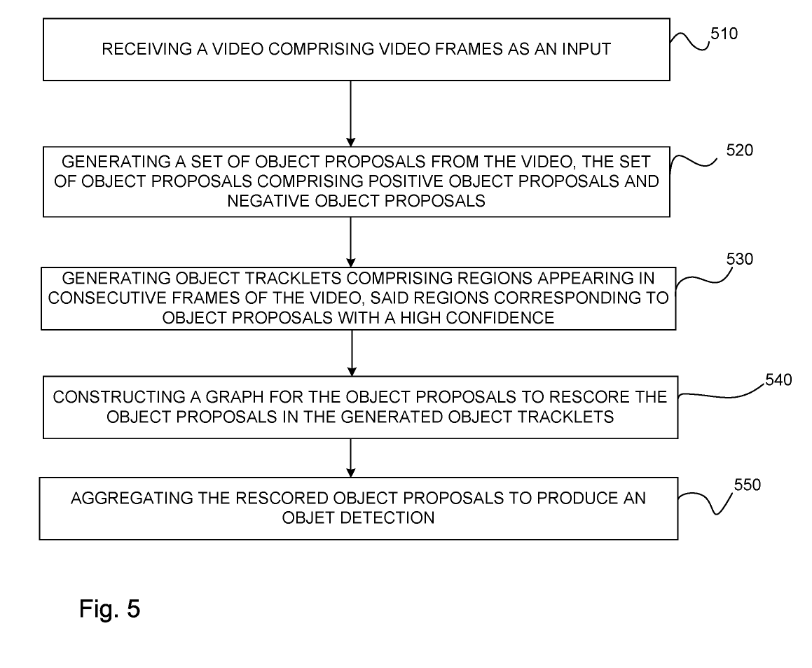

In FIG. 4, an example of tracklet graph is shown. In the FIG. 4 rectangles 400 indicate tracklets, circles 410, 420 represent object proposals, and triangles 430 stand for negative boxes. Solid circles 420 are proposals with high confidence whilst dashed circles 410 are weakly detected proposals.

The graph optimization is determined by minimizing an energy function E(Z) with respect to all nodes' confidence Z(Z∈[−1, 1]):

$${min}_{Z} E ( Z ) = {min}_{Z} μ {\sum }_{i = 1}^{N} {‖ {z}_{i} - {y}_{i} ‖}^{2} + {\sum }_{i , j = 1}^{N} {A}_{ij} {‖ {z}_{i} {d}_{i}^{- \frac{1}{2}} - {z}_{j} {d}_{j}^{- \frac{1}{2}} ‖}^{2} \qquad Equation 1$$

where μ is a parameter, and zᵢ are the desirable confidence of node i which are imposed by prior labelling γᵢ. The first term in Equation 1, i.e. Σᵢ₌₁^{N}∥zᵢ−γᵢ∥² is the fitting constraint which enforces the inference to comply with the prior knowledge, whilst the second term in Equation 1, i.e. Σ_{i,j=1}^{N}A_{i,j}∥zᵢdᵢ^{-1/2}∥² is smoothness constraint, which encourages the coherence of semantic confidence among adjacent similar nodes in feature space. Let the node degree matrix be defined as

dᵢ=Σⱼ₌₁^{N}A_{i,j},

where N=| [symbol] |.
Denoting S=D^{-1/2}AD^{-1/2}, this energy function can be minimized iteratively as

Z^{k+1}=αSZ^{k}+(1−α)Y

until convergence, where α controls the relative amount of confidence from its neighbours and its prior knowledge. Specifically, the affinity matrix A of Gt is symmetrically normalized in S, which is necessary for the convergence of the following iteration. In each iteration, each node adapts itself by receiving the information from its neighbours while preserving its initial confidence. The confidence is adapted symmetrically since S is symmetric.

The affinity matrix A of Gt is computed as the inner-product between neighboring nodes measured by the L2-normalized VGG-16 Net fc6 layer features Fᵢ of each box, i.e.,

a_{i,j}=<Fᵢ,Fⱼ>

Alternatively, the optimization problem is solved as a linear system of equations which is more efficient. Differentiating E(Z) with respect to Z, the result is

∇E(Z)|z=z*=Z*−SZ*+μ(Z*−Y)=0

which can be transformed as

$${Z}^{*} - \frac{1}{1 + μ} {SZ}^{*} - \frac{μ}{1 + μ} Y = 0 \qquad$$

Denoting

$$γ = \frac{μ}{1 + μ} ,$$

the result is (I−(1−γ)S)Z*=γY. The optimal solution for Z can be found using preconditioned conjugate gradient method with very fast convergence. The detection confidence of RCNN which are higher than a threshold η(η=0.1) is used to assign the values Y as initial positive nodes. The positive nodes whose detection confidences below η are deemed unlabeled and the values Y are assigned as 0. The values Y of all negative nodes are initially assigned as −1. The diffusion process may involve two separable confidence propagation from labeled (positive or negative) nodes to unlabeled nodes respectively, with initial labels Y in Equation 1 substituted as Y+ and Y− respectively:

$${Y}_{+} = \{ \begin{matrix}Y & if Y > 0 \\ 0 & otherwise\end{matrix} \\ and \\ {Y}_{-} = \{ \begin{matrix}- Y & if Y < 0 \\ 0 & otherwise\end{matrix} .$$

Both diffusion processes can be combined to produce more efficient and coherent labelling, taking advantage of the complementary properties of positive and negative nodes. The optimization may be performed for two diffusion processes simultaneously as follows:

z*=γ(I−(1−γ)S)⁻¹(Y₊−Y₋).

This enables a faster and stable optimization avoiding separate optimizations while giving equivalent results to the individual positive and negative label diffusion. Finally, the nodes of tracklets which are assigned with confidence Z<0 are removed from the corresponding tracklets. After this stage, the semantic confidence of all object proposals O, i.e., all tracklets, are rescored by incorporating the prior knowledge of proposals and the long-range dependencies.

### Tracklet Aggregation

On each frame, there may be more than one overlapping or non-overlapping object proposals, i.e., boxes, corresponding to multiple or the same object instances. Non-Maximum Suppression is performed to select the box with highest confidence as the detected object.

FIG. 12 is a flowchart illustrating a method according to an embodiment. A method comprises for example receiving a video comprising video frames as an input 510; generating set of object proposals from the video, the set of object proposals comprising positive object proposals and negative object proposals 520; generating object tracklets comprising regions appearing in consecutive frames of the video, said regions corresponding to object proposals with a high confidence 530; constructing a graph for the object proposals to rescore the object proposals in the generated object tracklets 540; and aggregating the rescored object proposals to produce an object detection 550.

An apparatus according to an embodiment comprises means for receiving a video comprising video frames as an input; means for generating set of object proposals from the video, the set of object proposals comprising positive object proposals and negative object proposals; means for generating object tracklets comprising regions appearing in consecutive frames of the video, said regions corresponding to object proposals with a high confidence; means for constructing a graph for the object proposals to rescore the object proposals in the generated object tracklets; and means for aggregating the rescored object proposals to produce an object detection. The means comprises a processor, a memory, and a computer program code residing in the memory.

The various embodiments may provide advantages.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

That which is claimed is:

1. A method, comprising:
receiving a video comprising video frames as an input;
generating a set of object proposals from the video, the set of object proposals comprising positive object proposals and negative object proposals;
generating object tracklets comprising regions appearing in consecutive frames of the video, said regions corresponding to object proposals with a high confidence;
constructing a graph for the object proposals to rescore the object proposals in the generated object tracklets; and
aggregating the rescored object proposals to produce an object detection.

2. The method according to claim 1, wherein negative object proposals are defined to be such object proposals whose detection score is below a first threshold.

3. The method according to claim 1, wherein object proposals with the high confidence are defined as object proposals having a detection score exceeding a second threshold.

4. The method according to claim 1, wherein generating object tracklets comprises tracking a proposal with the high confidence bidirectionally in the video.

5. The method according to claim 4, wherein generating object tracklets further comprises performing tracking iteratively.

6. The method according to claim 1, wherein rescoring the object proposals comprises two separable confidence propagation processes from labeled nodes to unlabeled nodes respectively.

7. The method according to claim 6, wherein the two separable confidence propagation processes are performed simultaneously.

8. The method according to claim 1, wherein aggregating the rescored object proposals comprises selecting the proposal with the highest confidence as a detected object.

9. The method according to claim 1, further comprising determining a graph optimization by minimizing an energy function with respect to all nodes' confidence.

10. An apparatus comprising at least one processor and a memory including computer program code, the memory and the computer program code configured to, with the at least one processor, cause the apparatus to perform at least the following:
receive a video comprising video frames as an input;
generate a set of object proposals from the video, the set of object proposals comprising positive object proposals and negative object proposals;
generate object tracklets comprising regions appearing in consecutive frames of the video, said regions corresponding to object proposals with a high confidence;
construct a graph for the object proposals to rescore the object proposals in the generated object tracklets; and
aggregating the rescored object proposals to produce an object detection.

11. The apparatus according to claim 10, wherein negative object proposals are defined to be such object proposals whose detection score is below a first threshold.

12. The apparatus according to claim 10, wherein object proposals with high confidence are defined as object proposals having a detection score exceeding a second threshold.

13. The apparatus according to claim 10, wherein generating object tracklets comprises tracking a proposal with the high confidence bidirectionally in the video.

14. The apparatus according to claim 13, wherein generating object tracklets further comprises performing tracking iteratively.

15. The apparatus according to claim 10, wherein rescoring the object proposals comprises two separable confidence propagation processes from labeled nodes to unlabeled nodes respectively.

16. The apparatus according to claim 15, wherein the two separable confidence propagation processes are performed simultaneously.

17. The apparatus according to claim 10, wherein aggregating the rescored object proposals comprises selecting the proposal with the highest confidence as a detected object

18. The apparatus according to claim 10, further comprising determining a graph optimization by minimizing an energy function with respect to all nodes' confidence.

19. A computer program product embodied on a non-transitory computer readable medium, comprising computer program code configured to, when executed on at least one processor, cause an apparatus or a system to:
receive a video frame as an input;
receive a video comprising video frames as an input;
generate set of object proposals from the video, the set of object proposals comprising positive object proposals and negative object proposals;
generate object tracklets comprising regions appearing in consecutive frames of the video, said regions corresponding to object proposals with a high confidence;
construct a graph for the object proposals to rescore the object proposals in the generated object tracklets; and
aggregate the rescored object proposals to produce object detection.
